(19) United States
(12) Patent Application Publication
(10) Pub. No.: US 2018/0232725 A1
(43) Pub. Date: Aug. 16, 2018

(54) PAYMENT TOKENIZATION USING SEPARATE TOKEN VAULT

(71) Applicant: ITS, INC., JOHNSTON, IA (US)

(72) Inventors: TERRY DEAN DOOLEY, WEST DES MOINES, IA (US); MANISH S. NATHWANI, GRIMES, IA (US); STEPHAN DWAYNE THOMASEE, JOHNSTON, IA (US)

(21) Appl. No.: 15/432,669

(22) Filed: Feb. 14, 2017

(51) Int. Cl. G06Q 20/36; G06Q 20/38

(52) U.S. Cl. CPC G06Q 20/36; G06Q 20/385

(57) ABSTRACT

Payment token processes employ a token vault separate from a token service provider. The token service provider continues to provide front-end token services, while the decoupled token vault assumes responsibilities that include, among other things, allocation of payment tokens to payment account identifiers of payment instruments during token enrollment and detokenization to obtain the payment account identifiers of the payment tokens during the processing of payment transactions.

### BACKGROUND

The advent of emerging technologies including the Internet raises concerns regarding the security of electronic payments using traditional payment instruments, such as credit cards and bank accounts. Such payments often involve the electronic transmission of a payment account identifier (e.g., a primary account number (PAN) or bank account number (BAN)) over unsecured networks. Additionally, in some cases, payment account identifiers may be stored in a variety of locations, including on users' mobile devices and e-commerce platforms. Both the electronic transmission and storage of payment account identifiers makes them particularly susceptible to theft, misuse, and other forms of fraud.

Payment tokenization is one solution that has been used to combat this problem. In payment tokenization, a payment token is a surrogate value that is used in place of a payment account identifier. A payment token can be limited to use in a specific domain representing the origination point of a transaction (e.g., a mobile device or channel such as an e-commerce platform), such that it can only be used to initiate a payment from that particular domain. This is intended to prevent the unauthorized use of payment tokens and associated payment account identifiers. The payment token may be static (e.g., can be used repeatedly) or for a one-time use.

Token service providers are entities that follow a basic framework of service offering to provide payment token management functions. These include controlled access to services such as tokenization (i.e., generation of a payment token for a payment account identifier), detokenization (identification of a payment account identifier for a given payment token), token suspension (put in place a temporary transaction block on a payment account identifier), and token resumption (remove any temporary block on a payment account identifier). Current implementations of token service providers follow a non-standard, proprietary approach to accessing these critical token services with restricted flexibility and choice when processing token-based payments.

Conventional tokenization processes rely on a token vault for provisioning and managing payment tokens using proprietary technologies. The token vault maintains a look-up pair that associates a particular token with a payment account identifier, which in turn requires management by the token vault through a proprietary payment token to payment account identifier mapping. The sheer concentration of payment account identifiers in the token vault makes the token vault an attractive and central target for attack. Further, the use of proprietary, and in some cases, untested and unscaled, technologies creates significant exposure for such token vaults.

Today, conventional token vaults are encapsulated, managed, and controlled entirely by the token service provider. In addition to managing the token vault, the token service provider also provides all token services associated with the management of the lifecycle of payment tokens. Such consolidated roles as both controller of the token vault and provider of all payment token services limits access and requires all parties to establish connectivity with a single entity, thereby exposing a broad attack vector.

### SUMMARY

Embodiments described in the present disclosure relate to, among other things, payment token processes that separate the role of a token vault from a token service provider. The token service provider continues to provide front-end token services, while the decoupled token vault assumes responsibilities that include, among other things, allocation of payment tokens to payment account identifiers of payment instruments (e.g., credit cards, debit cards, bank accounts, etc.) during token enrollment and detokenization to obtain the payment account identifiers of the payment tokens during the processing of payment transactions. By decoupling the token vault from the token service provider, the role of the token vault can be managed by an issuer of payment instruments or an entity designated by the issuer, thus eliminating a single aggregation point of tokens that was typically outside of the issuer's control.

In accordance with embodiments described herein, when a user (e.g., a cardholder or bank account holder) wishes to enroll a payment instrument, an enrollment request that contains the payment account identifier of the payment instrument is provided to a token service provider that provides front-end token services. The enrollment request is routed from the token service provider to the issuer of the payment instrument or an issuer processer. The issuer or issuer processor requests a payment token for the payment account identifier from a token vault that is separate from the token service provider. The token vault generates a payment token for the payment account identifier. In some configurations, the token vault randomly generates the payment token and stores the payment token in association with the payment account identifier in storage provided by the token vault. In other configurations, the token vault uses encryption to generate the payment token as a function of the payment account identifier. The payment token is then returned to the token service provider in response to the enrollment request.

When the user initiates a payment for a transaction using the payment token, a payment transaction request that includes the payment token is routed to the issuer or issuer processor. The token vault is then requested to detokenize the payment token to obtain the payment account identifier stored in association with the payment. The payment account identifier is verified to authorize the payment transaction request, and an approval response based on verifying the PAN is returned in response to the payment transaction request.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram illustrating an enrollment process to provision a payment token for a payment account identifier using encryption in accordance with some implementations of the present disclosure;

FIG. 2 is a block diagram illustrating a process of a payment transaction using an encryption-based payment token in accordance with some implementations of the present disclosure;

FIG. 3 is a block diagram illustrating a process for enrolling a payment account identifier to a payment token using a token service provider that is separate from a token vault provider in accordance with some implementations of the present disclosure;

FIG. 4 is a block diagram illustrating a process for payment transaction processing using a decoupled token vault in accordance with some implementations of the present disclosure; and

FIG. 5 is a block diagram of an exemplary computing environment suitable for use in implementations of the present disclosure.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Overview

As discussed herein, “tokenization” refers to a process of exchanging a sensitive data element with a non-sensitive data element, referred to as a “token.” “Detokenization” refers to the reverse process of obtaining the sensitive data element based on the token. In accordance with various aspects of the technology discussed herein, the sensitive data element is the payment account identifier of a payment instrument. As used herein, a “payment account identifier” is a number or other identifier used to authorize payment transactions. By way of example only and not limitation, a payment account identifier may be a primary account number (PAN) (e.g., credit card number, debit card number, gift card number, or other payment card number) or a bank account number (BAN) (e.g., account number with routing transit number, etc.). As used herein, a “payment instrument” refers to any type of payment card (e.g., credit card, debit card, gift card) and/or financial account (e.g., credit card account, checking account, etc.) through which a payment may be made.

The payment token for a given payment account identifier may be used throughout the relevant payment system to map back to the payment account identifier, but typically only for payments originating through the domain for which the payment token was provisioned. As used herein, a “domain” refers to a particular user device or channel. The “user device” may be any type of device through which a user may initiate a payment, such as a smartphone, tablet computer, or personal computer. A “channel” refers to an origination point of a payment transaction, such as a website or e-commerce platform.

Some embodiments of the present invention address shortcomings of current tokenization approaches by using encryption/decryption during the tokenization and detokenization process. As noted in the Background, current tokenization approaches use a token vault that stores pairs that each map a payment token to a corresponding payment account identifier. While payment account identifiers in a token vault are typically secured through proprietary means, the aggregation of payment account identifiers at a single location makes the token vault a target of attack to obtain the payment account identifiers. Some implementations of the present invention address this problem by using encryption to generate payment tokens for payment account identifiers and decryption to detokenize payment tokens to obtain the original payment account identifiers during payment transactions. Use of encryption during token generation and decryption during payment transaction processing may remove exposure associated with conventional token vaults as no token vault is needed, eliminating the single aggregation point of payment account identifiers.

Implementations may employ, for instance, a well-established, ubiquitous hardware encryption algorithm, such as those based on the Advanced Encryption Standard (“AES”) or the Triple Data Encryption Standard (“3DES”). Use of such standards leverage open industry hardware encryption standards and algorithms thereby reducing complexity, reducing costs, improving scalability, and ensuring a robust defensible security architecture that may adapt as encryption algorithms and methodologies evolve. These encryption standards already support various services within today's payment ecosystem such as, but not limited to: PIN management as defined by X9/TR-39, X9.8 specifications; PIN generation, translation and verification; card verification value/code verification (CVV/CVC/CVV2/CVC2); EMV cryptogram (ARQC/ARPC) generation and verification; 3-D Secure UCAF (AAV/CAAV) generation and verification. The technologies supporting these services constitute examples of open, scalable and vendor neutral algorithms to solve their respective domain functionality.

According to various implementations of the invention, tokenization may be accomplished using cryptographic standards and algorithms that rely on public/private key pairs that only an issuer or an “on-behalf-of” processor (i.e., an issuer processor) share. Such an approach may be adapted for each of the use cases defined in “EMV Payment Tokenisation Specification—Technical Framework,” EMVCo, March 2014. Doing so provides an open, scalable environment that ensures payment token provisioning, token verification, detokenization, and lifecycle management may be supported by multiple entities. Importantly, this system may eliminate a single concentration of all tokens at a token vault, reducing security risk while providing issuers with flexibility and choice to the payments ecosystem.

Further embodiments of the present technology are directed to separating token services from a token vault. Conventionally, a token service provider offers both front-end token services and a token vault. This traditional approach of having the token service provider operate as both controller of the token vault and provider of all payment token services limits access and requires all parties to establish connectivity with a single entity, thereby exposing a broad attack vector.

Accordingly, some embodiments of the present disclosure decouple the role of the token vault from front-end token services in order to, among other things, open access to the token vault to issuers, provide more flexibility, and eliminate the need to establish connectivity with a single entity that exposes a broad attack vector. In accordance with such implementations, the role of a token vault is managed by a party (e.g., a “token vault provider”) separate from the token service provider. For instance, the role of the token vault provider may be provided by the issuer, issuer processor, or other third party.

Separating these roles in accordance with embodiments described herein allows issuers, whose payment account identifiers are being virtualized or digitized for tokenization, to limit a degree and extent to which those payment account identifiers are proliferated and propagated by allowing the issuers to assume or otherwise have more control over the responsibilities of the token vault. Separating the token vault from the front-end token services also provides a competitive implementation for issuer tokenization and token lifecycle management with maximum flexibility, product choice, and unbiased access to services. Separating the token vault and token services roles further eliminates a single aggregation point of payment tokens and payment account identifiers associated with conventional token service providers, thereby mitigating certain risks of the issuers that are otherwise outside the issuers' control. Such implementations also permit the issuer to choose the entities to which it designates the responsibilities of a token vault provider (e.g., the issuer itself, issuer processor, and/or another party).

In accordance with various implementations, the role of the token vault provider may include, but not be limited to: 1) allocating a payment token upon request from a token service provider to enroll a payment instrument (e.g., as part of an extension to an identification and verification (“ID&V”); 2) returning the payment token to the requesting token service provider; 3) returning appropriate issuer-specific, EMV-related cryptographic keys, where applicable (e.g., in an NFC-based provisioning request for securely associating and storing within a secure element or HCE-equivalent); 4) returning token status through active notifications to the token service provider throughout the lifecycle of the payment token; and 5) managing and providing portal services of a payment token lifecycle to the token provisioning entity (e.g., an issuer, issuer processor, or other entity).

When the token vault is provided by the issuer, the issuer may not only provide ID&V services, but may also generate and provision payment tokens and any other attributes such as cryptographic keys, back to the requestor via the token service provider. Doing so provides greater flexibility and choice for various entities in the payments ecosystem. In some implementations, in order to implement such additional functionality, ISO messaging (i.e., international standards organization messaging including ISO 8553, ISO 20022, and/or other ISO specifications), particularly associated with the ID&V request, may accommodate optional support for data attributes or data elements in the response from an issuer processor or issuer that reflect issuer specific attributes such as payment tokens, encrypted cryptographic keys, etc.

In some implementations, the decoupled token vault operates in a manner similar to traditional token vaults. In other words, the token vault is used to tokenize payment account identifiers, store mappings of payment tokens to payment account identifiers, and detokenize payment tokens during payment transactions using the mappings. In other implementations, the decoupled token vault employs encryption and decryption during tokenization and detokenization, respectively, as previously described. In such implementations, the token vault does not need to store any mappings of payment tokens to payment account identifiers, thereby eliminating an aggregation point of payment account identifiers and further enhancing security.

Payment Tokenization using Encryption

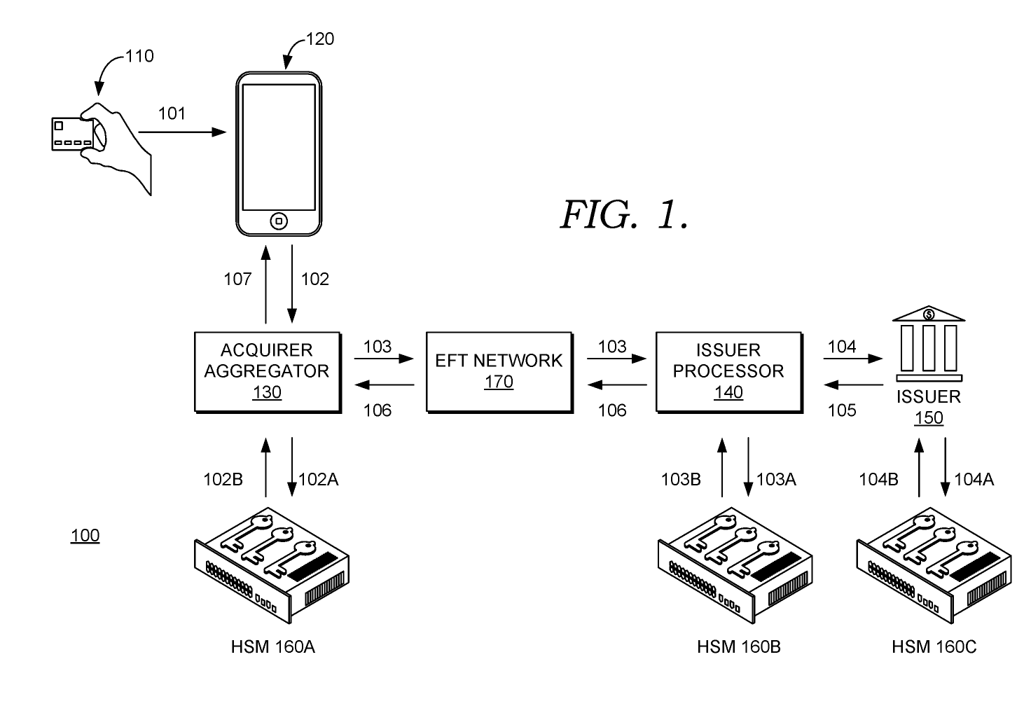

As previously indicated, some implementations of the present disclosure employ encryption when generating payment tokens and decryption to access a payment account identifier during payment transaction processing. With reference now to the drawings, FIG. 1 is a block diagram illustrating an exemplary system showing an enrollment process 100 to provision a payment token for a payment account identifier using encryption in accordance with some implementations of the present disclosure. The system shown in FIG. 1 provides one pathway and enrollment process for provisioning a payment token by way of an example for illustration purposes only. It should be understood that this and other arrangements described herein are set forth only as examples. Other arrangements, pathways, processes, and elements (e.g., machines, interfaces, functions, orders, and groupings of functions, etc.) can be used in addition to or instead of those shown, and some elements may be omitted altogether. For instance, a different pathway with different components and a different process between components can occur between an origination point of an enrollment request and a location at which encryption for tokenization occurs. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

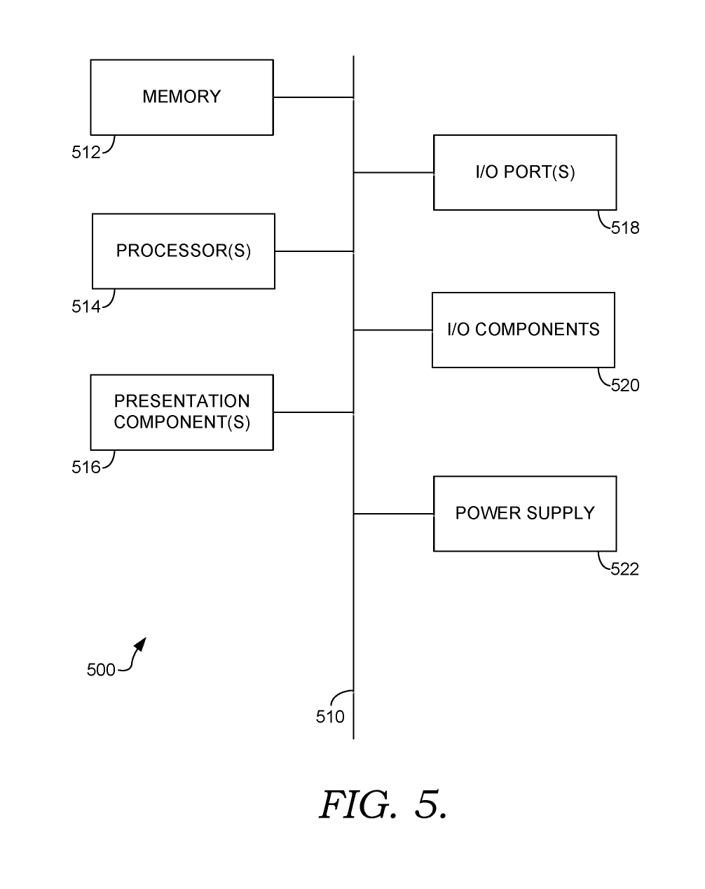

FIG. 1 is an example of a suitable architecture for implementing certain aspects of the present disclosure. Each of the components shown in FIG. 1 and other figures discussed herein can be provided on one or more computer devices, such as the computing device 500 of FIG. 5, discussed below. The devices can communicate via a network, which may include, without limitation, one or more local area networks (LANs) and/or wide area networks (WANs). Such networking environments are commonplace in offices, enterprise-wide computer networks, intranets, and the Internet. It should be understood that any number of devices may be employed within the system within the scope of the present invention. Each may comprise a single device or multiple devices cooperating in a distributed environment. Additionally, other components not shown may also be included within the network environment.

In an operation 101, a user 110 (e.g., a cardholder) initiates an enrollment process for a payment instrument. For instance, the user 110 can use a wallet or payment application on a user device 120 (e.g., smartphone, mobile device, computer, etc.) or log into an e-commerce website using a browser or other application on the computing device 120 to enroll the payment instrument. Various online or internet-based channels and their associated devices may be used in connection with enrollment of the payment instrument.

At operation 102, an enrollment request is transmitted to an acquirer aggregator 130 in order to initiate a process to enroll credentials associated with the payment instrument. The acquirer aggregator 130 may be any aggregation point with whom the payment application or e-commerce site originating the enrollment request is configured to employ for tokenization and payment transactions.

At a minimum, the credentials provided with the enrollment request include the payment account identifier for the payment instrument. As used herein, “credentials” associated with a payment instrument can also include other attributes and/or parameters that govern outcome of processing transactions for the payment instrument. Such credentials may include card limits, card balances, card status (e.g., open, closed, hot card, etc.), temporary card block and/or other credentials. In some implementations, the enrollment request also includes domain information. As used herein, “domain information” corresponds to attributes and/or parameters that govern access by entities in a particular access point (e.g., user device, internet browser, mobile client application, e-commerce URL, etc.) to services such as tokenization and detokenization during payment processing. For example, the domain information can specify a particular user device identifier (e.g., MAC address, IP address, cookie, mobile device identifier, etc.) or channel identifier (e.g., website URL, e-commerce URL, etc.).

In some implementations, the acquirer aggregator 130 encrypts the credentials and/or domain information to provide secure transmission of the information with the enrollment request. This is illustrated by operation 102A in which the credentials and/or domain information are provided to a hardware security module (HSM) 160A and operation 102B in which the HSM 160A responds by providing encrypted credentials and/or domain information. The encryption may employ various encryption keys (e.g., symmetric, public/private pairs, etc.), which may be similar to those used to encrypt a PIN block in existing payment ecosystems. The HSM 160A and other HSMs discussed herein (including HSM 160B and HSM 160C) may each comprise a hardware crypto-processor configured to support encryptions and/or decryption requests.

As shown in FIG. 1, an EFT network 170 acts as an arbiter of transactions (e.g., enrollment requests and payment transactions) between an acquirer aggregator 130 and an issuer 150. The EFT network 170 may route transactions to another network or EFT processor with a connection to issuer 150. Accordingly, as shown at operation 103, acquirer aggregator 130 transmits an enrollment request to issuer processor 140 via EFT network 170. In some implementations, the acquirer aggregator 130 may select from among various issuer processors, such as the issuer processor 140 and also may select from among various routes and/or channels with which to transmit the enrollment request to the selected issuer processor 140. The issuer processor 140 provides financial services such as authorization, reconciliation, authentication, generation, and credential verification. The issuer processor 140 can also provide connectivity/access to/from the issuer 150 sitting between the EFT network 170 and issuer 150 as shown in FIG. 1.

If the credentials and domain information are encrypted when received by the issuer processor 140, the issuer processor 140 may handle the encrypted credentials and/or domain information in a number of different ways. For instance, in some implementations, the issuer processor 140 translates the encrypted credentials and/or domain information from encryption using encryption keys shared with the acquirer aggregator 130 to encryption keys shared with the issuer 150. In other implementations in which issuer processor 140 supports authorization services on behalf of the issuer 150, the issuer processor 140 may decrypt the encrypted credentials and/or domain information for purposes of verification. By way of example to illustrate, FIG. 1 shows an operation 103A in which encrypted credentials and/or domain information are provided to a HSM 160B to perform the encryption translation or decryption, and at operation 103B, the HSM 160B returns either: 1) encrypted credentials and/or domain information (e.g., encrypted using encryption keys shared with the issuer 150); or 2) decrypted credentials and/or domain information for purposes of verification.

At operation 104, the issuer processor 140 transmits the enrollment request to the issuer 150. Generally, after the enrollment request is received at the issuer 150, the credentials and domain information are verified, and a payment token is generated using encryption. In accordance with implementations of the present disclosure, the payment token is generated using encryption at least as a function of the payment account identifier. This allows the payment account identifier to be retrieved, for instance during payment processing (as will be described in further detail below) by decrypting the payment token. In other implementations, the payment token can be generated using the domain information as well. The payment token may further be generated using a token bank identification number (BIN; sometimes also referred to as the issuer identification number (IIN)). As known in the art, a BIN is a standard term that represents the prefix (first N digits) of a payment account identifier and is typically used as a component to make decisions for transaction routing. It can also be used to set BIN-level processing parameters that apply to all payment instruments using that BIN (i.e., a BIN is a prefix to a large number of actual payment account identifiers beginning with that prefix). Token BINs are similar in nature with the difference that they are prefixes for payment tokens rather than actual payment account identifiers. Transaction originating platforms such as e-commerce websites, merchant point-of-sale (POS) terminals, and EFT networks handle payment tokens and token BINs like payment account identifiers and “real” BINs.

In accordance with some implementations, the payment token may be generated using issuer-specific token keys. As such, the issuer 150 has control over the token keys and can share the token keys, if desired, with entities with which the issuer 150 has a trusted relationship. Token keys can be used to tokenize payment account identifiers into payment tokens and detokenize payment tokens back into payment account identifiers. Token keys can be used in conjunction with encryption functions and provided by standard hardware/software encryption platforms, such as a HSM.

The encryption used in accordance with implementations of the present disclosure generates a payment token that is unique. In implementations in which the payment token is generated using domain information, the payment token may be applicable only to a specific domain corresponding to the domain information. For instance, such a payment token is associated with a specific set of user credentials in connection with a specific user device, payment application, or e-commerce site.

By way of example to illustrate, at operation 104A in FIG. 1, the credentials and domain information are provided to a HSM 160C. If the credentials and/or domain information are encrypted when received, the HSM 160C first decrypts the encrypted information. The HSM 160C generates a payment token based on the credentials, domain information, and/or a token BIN. At operation 104B, the HSM 160C responds to the issuer 150 with decrypted credentials and/or domain information for verification (if previously encrypted). The HSM 160C also responds to issuer 150 with the generated payment token.

At operation 105, the issuer 150 responds to the enrollment request by providing an issuer approval and the generated payment token to the issuer processor 140. In some implementations, the issuer 150 may also provide issuer-specific, EMV-related cryptographic keys to the issuer processor 140. Such cryptographic keys may be useful with domain-specific credentials that represent an NFC-based provisioning request for securely associating and storing payment tokens within a secure element or HCE-equivalent.

At operation 106, the issuer processor 140 forwards the issuer approval and payment token back to the acquirer aggregator 130 (e.g., via the EFT network 170). The acquirer aggregator 130 then responds to the original enrollment request (e.g., from the payment application or e-commerce site) by providing the issuer approval and payment token to the payment application or e-commerce site, which may store the payment token for subsequent use during purchase transactions.

In some implementations, the response path at operations 105 and/or 106 could be encrypted/decrypted to further enhance the transmission security. By way of example only and not limitation, this could include using the HSM 160B and/or HSM 160C to encrypt the response data and using the HSM 160A to decrypt the response data.

In various implementations of the present disclosure, management of the payment token and its lifecycle (i.e., lifecycle management) may be performed by the issuer 150 or the issuer processor 140 if the issuer processer 140 provides such management services on behalf of the issuer 150. In some implementations of the invention, lifecycle management of the token credentials may be analogous and similar to management of physical plastic cards currently in place by the issuer 150 in accordance with industry “best practices.”

While the process 100 describes encryption to generate the payment token occurring at the issuer 150, in further implementations, the payment token can be generated using encryption at the issuer processor 140, for instance, using the HSM 160B.

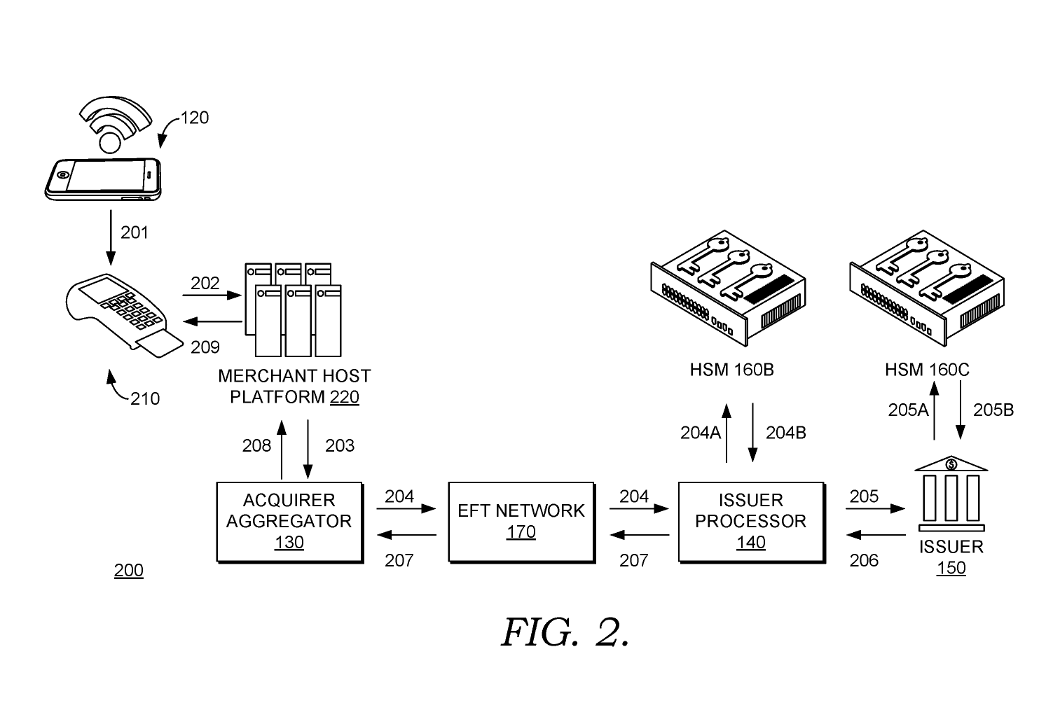

After a payment token has been generated for a payment account identifier, the payment token may be employed during a payment transaction by using decryption to detokenize the payment token. FIG. 2 illustrates a process 200 of a payment transaction using an encryption-based payment token in accordance with some implementations of the present disclosure. FIG. 2 illustrates one pathway and process for a payment transaction by way of an example only. It should be understood that other arrangements, pathways, processes, and elements (e.g., machines, interfaces, functions, orders, and groupings of functions, etc.) can be used in addition to or instead of those shown, and some elements may be omitted altogether. For instance, a different pathway with different components and a different process between components can occur between an origination point of a payment transaction and a location at which decryption for detokenization occurs.

At operation 201, the user 110 initiates a payment transaction using payment token generated, for instance, in accordance with the process 100 of FIG. 1. The payment token may be stored locally on the user device 120 or remotely, for instance, at an e-commerce site. By way of example to illustrate, FIG. 2 shows an implementation in which the payment token is stored locally on the user device 120 and the payment transaction is initiated by the user device 120 providing the payment token to a terminal 210, for instance, using near-field communication (NFC). The payment transaction may be initiated in other ways in other implementations, for instance, via an e-commerce site.

At operation 202, a payment transaction request that includes the payment token is sent to a merchant host platform 220. The merchant host platform 220 evaluates the payment token to determine the token BIN associated with the payment token in order to determine routing of the payment transaction request. At operation 203, based on the token BIN, the merchant host platform 220 routes the payment transaction request to the appropriate acquirer aggregator 130. At operation 204, the acquirer aggregator 130 routes the payment transaction request to an appropriate issuer processor 140, for instance, via the EFT network 170.

The payment token in the payment transaction request is detokenized to obtain a corresponding payment account identifier and, in some implementations, domain information. The detokenization includes decrypting the payment token using the token keys employed to generate the payment token (e.g., during the process 100 of FIG. 1). This detokenization can be performed by or on behalf of the issuer processor 140 or the issuer 150. For instance, in some implementations, the issuer processor 140 requests the HSM 160B to detokenize the payment token at operation 204A. The HSM 160B can also verify the EMV cryptography, if applicable. In such implementations, the HSM 160B responds to the issuer processor 140 with the original payment account identifier and, in some instances, domain information. The issuer processor 140 would then transmit the payment transaction request with the payment account identifier (and domain information, if applicable) to the issuer 150 for authorization of the payment transaction.

In other implementations, the issuer processor 140 does not use the HSM 160B to detokenize the payment token. Instead, the issuer processor 140 forwards the payment transaction request with the payment token to the issuer 150. In such implementations, the issuer 150 requests the HSM 160C to detokenize the payment token at operation 205A. The HSM 160C can also verify the EMV cryptography, if applicable. The HSM 160C then responds to the issuer 150 with the original payment account identifier and, in some instances, domain information, as shown at operation 205B. The issuer 150 then examines the payment account identifier and/or domain information for authorization of the payment transaction.

In either implementation, after the issuer 150 authorizes the payment transaction based on the payment account identifier and/or domain information, the issuer 150 responds back to the issuer processor 140 with an approval transaction that includes the payment account identifier or the payment token, as shown at operation 206.

At operation 207, the issuer processor 140 sends the approval transaction and payment token to the acquirer aggregator 130, for instance, via the EFT network 170. At operation 208, the acquirer aggregator 130 forwards the approval transaction back to merchant host platform 220. At operation 209, the merchant host platform 220 provides the approval transaction to terminal 210 (or e-commerce site in other implementations), thereby completing authorization and approval of the payment transaction.

Decoupling Token Vault from Token Services

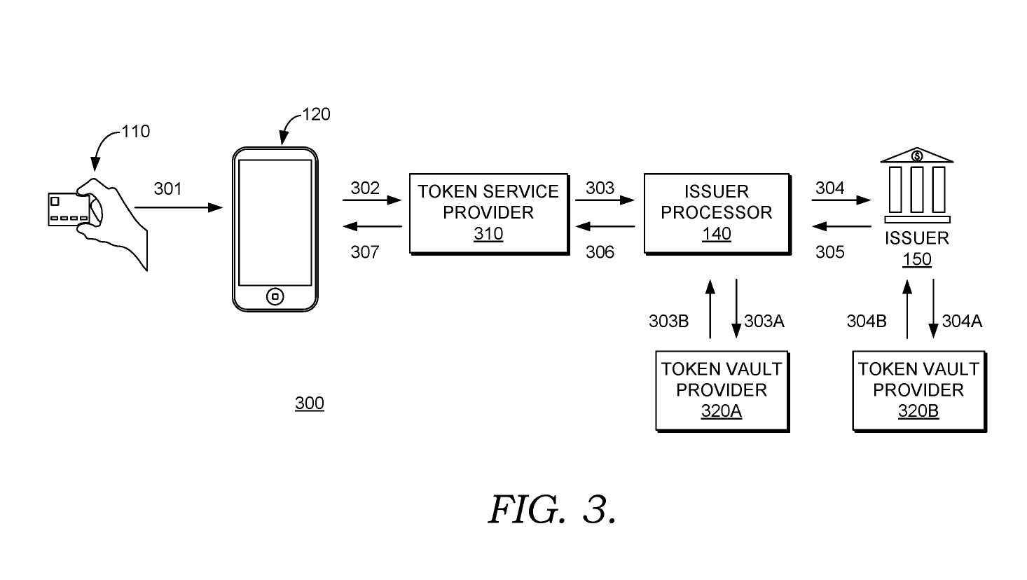

As previously discussed, some implementations of the present disclosure are directed to decoupling a token vault from front-end token services. This allows the token vault to be maintained and operated by entities other than the token service provider. FIG. 3 illustrates a process 300 for enrolling a payment account identifier to a payment token using a token service provider that is separate from a token vault provider in accordance with various implementations of the present technology. FIG. 3 illustrates one pathway and process for a tokenization by way of an example only. It should be understood that other arrangements, pathways, processes, and elements (e.g., machines, interfaces, functions, orders, and groupings of functions, etc.) can be used in addition to or instead of those shown, and some elements may be omitted altogether. For instance, a different pathway with different components and a different process between components can occur between an origination point of an enrollment request and a location at which tokenization occurs.

As shown at operation 301, a user 110 initiates an enrollment process for a payment instrument. For instance, the user 110 can use a wallet or payment application on a user device 120 (e.g., smartphone, mobile device, computer, etc.) or log into an e-commerce website using a browser or other application on the computing device 120 to enroll the payment instrument. Various online or internet-based channels and their associated devices may be used in connection with enrollment of the payment instrument.

At operation 302, an enrollment request is transmitted to a token service provider 310 in order to initiate a process to enroll credentials associated with the payment instrument. As noted above, credentials associated with a payment instrument can include, for instance, attributes and/or parameters that govern outcome or processing transactions for the payment instrument. At a minimum, the credentials include the payment account identifier for the payment instrument. The enrollment request may include additional information, such as, domain information that governs access by entities within certain domains (e.g., devices, websites) to tokenization and payment transaction services.

At operation 303, the token service provider 310 transmits the enrollment request to issuer processor 140. In some implementations, the token service provider 310 may select from among various issuer processors (or issuers) based on a BIN for which the payment account identifier is being enrolled. In some implementations of the invention, the token service provider 310 may select from among various routes and/or channels with which to transmit the enrollment request to the selected issuer processor 140. In some implementations, the enrollment request may include an identification and verification (ID&V) request to the selected issuer processor 140.

Tokenization may be performed in conjunction with the issuer processer 140 or an issuer 150 in accordance with various implementations of the present disclosure. When performed in conjunction with the issuer processor 140, at operation 303A, the issuer processor 140 requests a token vault provider 320A to generate a payment token based on the enrollment request. The token vault provider 320A may be the issuer processor 140 or provided by a third party separate from the issuer processor 140. In some configurations, the payment token is randomly generated and stored by the token vault provider 320A in a mapping between the payment token and a payment account identifier and/or other information. In other configurations, the payment token is generated using encryption as a function of information included in the enrollment request (e.g., payment account identifier, domain information, and/or a token BIN). In such configurations, the token vault provider 320A does not need to store a mapping between the payment token and the payment account identifier.

At operation 303B, the token vault provider 320A provides the issuer processor 140 with the generated payment token. At operation 304, the issuer processor 140 forwards the enrollment request to the issuer 150 in order to verify the credentials. This enrollment request may correspond to an ID&V request. In some implementations, the issuer processor 140 may authorize and approve the ID&V request on behalf of the issuer 150. In this case, the issuer 150 responds to the request from issuer processor 140 by providing the issuer processor 140 with an approval.

In other implementations, tokenization is performed in conjunction with the issuer 150. In such implementations, the issuer processor 140 does not request the token vault provider 320A to provide a payment token (i.e., operations 303A and 303B are not performed). Instead, the issuer 150 requests a token vault provider 320B at operation 304A to generate a payment token based on the enrollment request. The token vault provider 320B may be the issuer 150 or provided by a third party separate from the issuer 150. In some configurations, the payment token is randomly generated and stored by the token vault provider 320B in a mapping between the payment token and a payment account identifier and/or other information. In other configurations, the payment token is generated using encryption as a function of information included in the enrollment request (e.g., payment account identifier, domain information, and/or a token BIN). In such configurations, the token vault provider 320B does not need to store a mapping between the payment token and the payment account identifier.

At operation 304B, the token vault provider 320B provides the issuer 150 with the generated payment token. In some implementations of the invention, the token vault provider 320B may also provide the issuer 150 with appropriate issuer-specific, EMV-related cryptographic keys (e.g., for a domain specific credential that represents an NFC-based provisioning request for securely associating and storing within a secure element or HCE-equivalent). At operation 305, the issuer 150 responds to the enrollment request from the issuer processor 140 with an approval.

At operation 306, the issuer processor 140 responds to the enrollment request from the token service provider 310 by providing the token service provider 310 with the approval from issuer 150 and the payment token. At operation 307, the token service provider 310 then responds to the original enrollment request (e.g., from the payment application or e-commerce site) by providing the issuer approval and payment token to the payment application or e-commerce site, which may store the payment token for subsequent use during purchase transactions.

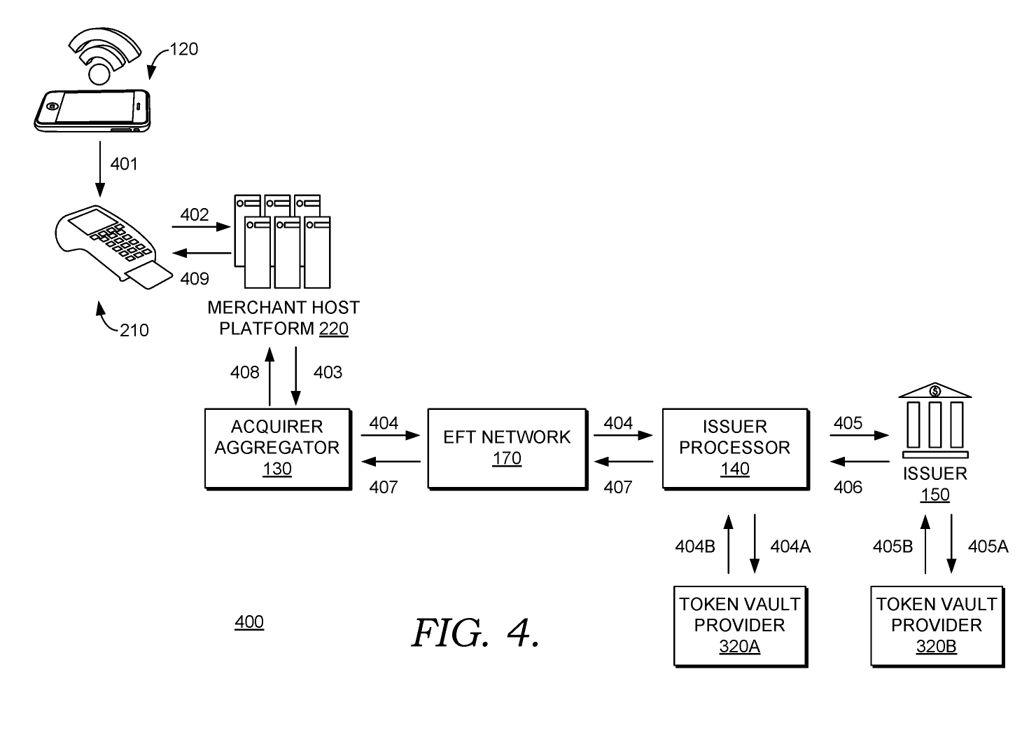

After a payment token has been generated for a payment account identifier, the payment token may be employed during a payment transaction by using the separate token vault to detokenize the payment token. FIG. 4 illustrates a process 400 for payment transaction processing using a decoupled token vault in accordance with some implementations of the present technology. FIG. 4 illustrates one pathway and process for a payment transaction by way of an example only. It should be understood that other arrangements, pathways, processes, and elements (e.g., machines, interfaces, functions, orders, and groupings of functions, etc.) can be used in addition to or instead of those shown, and some elements may be omitted altogether. For instance, a different pathway with different components and a different process between components can occur between an origination point of a payment transaction and a location at which detokenization occurs.

As shown at operation 401, a user 110 initiates a payment using a payment instrument that has undergone the enrollment process in accordance with the process 300 of FIG. 3. The payment token for the payment instrument may be stored locally on the user device 120 or remotely, for instance, at an e-commerce site. For instance, FIG. 4 illustrates an implementation in which the payment token is stored locally on the user device 120 and the payment transaction is initiated by the user device 120 providing the payment token to a terminal 210, for instance, using near-field communication (NFC). The payment transaction may be initiated in other ways in other implementations, for instance, via an e-commerce site.

At operation 402, a payment transaction request that includes the payment token is sent to a merchant host platform 220. The merchant host platform 220 evaluates the payment token to determine the token BIN associated with the payment token in order to determine routing of the payment transaction request. At operation 403, based on the token BIN, the merchant host platform 220 routes the payment transaction request to the appropriate acquirer aggregator 130. At operation 404, the acquirer aggregator 130 routes the payment transaction request to an appropriate issuer processor 140, for instance, via an EFT network 170.

In various embodiments of the present technology, a token vault provider that provides detokenization of the payment token for the payment transaction may be associated with the issuer processor 140 or the issuer 150. Accordingly, in some implementations, at operation 404A, the issuer processor 140 requests the token vault provider 320A to detokenize the payment token in the payment transaction request, as well as verify the EMV cryptography, if applicable. In such implementations, at operation 404B, the token vault provider 320A responds to the issuer processor 140 by providing the issuer processor 140 with the payment account identifier associated with the payment token. This may include looking up the payment account identifier stored in association with the payment token in a token vault or using decryption to derive the payment account identifier from the payment token (if encryption was used to generate the payment token from the payment account identifier). In this implementation, the issuer processor 140 transmits the payment transaction request with the payment account identifier to issuer 150 for authorization, as shown at operation 405, and the issuer responds back to the issuer processor 140 with an approval transaction at operation 406.

In further implementations, the token vault provider is associated with the issuer 150. In such implementations, the issuer processor 140 does not request the token vault provider 320A to provide detokenize the payment token (i.e., operations 404A and 404B are not performed). Instead, the issuer processor 140 sends the payment transaction request with the payment token as well as EMV data, if applicable, to the issuer 150 at operation 405. In such implementations, at operation 405A, the issuer 150 requests the token vault provider 320B to detokenize the payment token in the payment transaction request, as well as verify the EMV cryptography, if applicable. In such implementations, the token vault provider 320B may look up the payment account identifier stored in association with the payment token in a token vault or use decryption to derive the payment account identifier from the payment token (if encryption was used to generate the payment token from the payment account identifier). At operation 405B, the token vault provider 320B responds to the issuer 150 by providing the issuer 150 with the payment account identifier. The issuer 150 authorizes the payment transaction based on the payment account identifier and responds back to the issuer processor 140 with an approval transaction and the token credentials at operation 406.

At operation 407, the issuer processor 140 sends the approval transaction and payment token to the acquirer aggregator 130, for instance, via the EFT network 170. At operation 408, the acquirer aggregator 130 forwards the approval transaction back to merchant host platform 220. At operation 409, the merchant host platform 220 provides the approval transaction to terminal 210 (or e-commerce site in other implementations), thereby completing authorization and approval of the payment transaction.

### General Computing Environment

Having described implementations of the present disclosure, an exemplary operating environment in which embodiments of the present invention may be implemented is described below in order to provide a general context for various aspects of the present disclosure. Referring initially to FIG. 5 in particular, an exemplary operating environment for implementing embodiments of the present invention is shown and designated generally as computing device 500. Computing device 500 is but one example of a suitable computing environment and is not intended to suggest any limitation as to the scope of use or functionality of the invention. Neither should the computing device 500 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 5, computing device 500 includes bus 510 that directly or indirectly couples the following devices: memory 512, one or more processors 514, one or more presentation components 516, input/output (I/O) ports 518, input/output components 520, and illustrative power supply 522. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 5 is merely illustrative of an exemplary computing device that can be used in connection with one or more embodiments of the present invention. Distinction is not made between such categories as “workstation”, “server”, “laptop”, “hand-held device”, etc., as all are contemplated within the scope of FIG. 5 and reference to “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 512 includes computer storage media in the form of volatile and/or nonvolatile memory. The memory may be removable, non-removable, or a combination thereof. Exemplary hardware devices include solid-state memory, hard drives, optical-disc drives, etc. Computing device 500 includes one or more processors that read data from various entities such as memory 512 or I/O components 520. Presentation component(s) 516 present data indications to a user or other device. Exemplary presentation components include a display device, speaker, printing component, vibrating component, etc.

I/O ports 518 allow computing device 500 to be logically coupled to other devices including I/O components 520, some of which may be built in. Illustrative components include a microphone, joystick, game pad, satellite dish, scanner, printer, wireless device, etc. The I/O components 520 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 500. The computing device 500 may be equipped with depth cameras, such as, stereoscopic camera systems, infrared camera systems, RGB camera systems, and combinations of these for gesture detection and recognition. Additionally, the computing device 500 may be equipped with accelerometers or gyroscopes that enable detection of motion.

As described above, implementations of the present disclosure relate to payment tokenization using encryption. Further implementations relate to decoupling a token vault from front-end token services. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when executed by one or more computing devices, cause the one or more computing devices to perform operations, the operations comprising:
receiving, at a token vault provider, a request to tokenize a payment account identifier of a payment instrument, the request to tokenize the payment account identifier being communicated to the token vault provider based on an enrollment request from a token service provider providing front-end token services separate from the token vault provider;
generating a payment token for the PAN; and
returning the payment token to the token service provider.

2. The one or more computer storage media of claim 1, wherein the enrollment request is communicated from the token service provider through an issuer processor selected based on a bank identification number of the payment account identifier.

3. The one or more computer storage media of claim 1, wherein the request to tokenize the payment account identifier is received at the token vault provider from an issuer or issuer processor in response to the issuer or issuer processor receiving the enrollment request from the token service provider.

4. The one or more computer storage media of claim 1, wherein the payment token is generated as a function of the payment account identifier.

5. The one or more computer storage media of claim 4, wherein the enrollment request further includes domain information and the payment token is generated as a function of the payment account identifier and the domain information.

6. The one or more computer storage media of claim 5, wherein the payment token is further generated as a function of a bank identification number of an issuer that issued the payment instrument.

7. The one or more computer storage media of claim 1, wherein the operations further comprise: storing the payment token in association with the payment account identifier in a token vault of the token vault provider.

8. A computer-implemented method for payment tokenization, the method comprising:
receiving, at a server device of an issuer or an issuer processor, an enrollment request to enroll a payment account identifier of a payment instrument for payment tokenization, the enrollment request being communicated to the server device from a token service provider providing front-end token services;
requesting a payment token for the payment account identifier from a token vault provider separate from the token service provider, wherein the token vault provider generates a payment token for the payment account identifier;
receiving the payment token from the token vault provider; and
returning, to the token service provider, a response to the enrollment request that includes the payment token.

9. The method of claim 8, wherein the enrollment request is routed from the token service provider to the server device based on a bank identification number of the payment account identifier.

10. The method of claim 8, wherein the payment token is generated as a function of the payment account identifier.

11. The method of claim 10, wherein the enrollment request further includes domain information and the payment token is generated as a function of the payment account identifier and the domain information

12. The method of claim 11, wherein the payment token is further generated as a function of a bank identification number of the issuer that issued the payment instrument.

13. The method of claim 8, wherein the method further comprises approving the enrollment request, and wherein the response to the enrollment request further includes an approval indication.

14. The method of claim 8, wherein the method further comprises:
receiving, at the server device, a payment transaction request that includes the payment token;
requesting the token vault provider to detokenize the payment token to obtain the payment account identifier;
verifying the payment account identifier to authorize the payment transaction request; and
returning an approval response based on verifying the payment account identifier.

15. The method of claim 14, wherein the payment transaction request is routed to the server device based on a bank identification number associated with the payment token.

16. A server device of an issuer or issuer processor, the server device comprising:
one or more processors; and
one or more computer storage media storing computer-useable instructions that, when used by the one or more processors, cause the one or more processors to:
receive a payment transaction request that includes a payment token;
request a token vault provider to detokenize the payment token to obtain a payment account identifier of a payment instrument, the token vault provider being separate from a token server provider providing front-end token services;
verify the payment account identifier to authorize the payment transaction request; and
return an approval response based on verifying the payment account identifier.

17. The server device of claim 16, wherein the payment transaction request is routed to the server device based on a bank identification number of the payment account identifier.

18. The server device of claim 17, wherein the payment transaction request is routed to the server device through a communication pathway without being communicated to the token service provider.

19. The server device of claim 16, wherein the server device corresponds to the issuer processor and wherein verifying the payment account identifier to authorize the payment transaction request comprises transmitting the payment transaction request with the payment account identifier to a second server device of the issuer for authorization.

20. The server device of claim 16, wherein the approval response includes the payment token.
